(19) United States
(12) Patent Application Publication
(10) Pub. No.: US 2010/0319337 A1
(43) Pub. Date: Dec. 23, 2010

(54) HYDROSTATIC DRIVE SYSTEM

(75) Inventors: Thilo Jene, Spiesen-Elversberg (DE); Achim Schütz, Nunschweiler (DE)

Correspondence Address: BROWDY AND NEIMARK, P.L.L.C.;624 NINTH STREET, NW, SUITE 300, WASHINGTON, DC, 20001-5303, US

(73) Assignee: Terex Demag GmbH, Zweibrucken (DE)

(21) Appl. No.: 12/735,812

(22) PCT Filed: Feb. 3, 2009
(86) PCT No.: PCT/EP2009/000688

§ 371 Date: Aug. 19, 2010

(30) Foreign Application Priority Data
Feb. 19, 2008 (DE) 10 2008 010 270.9

(51) Int. Cl. F15B 11/00

(52) U.S. Cl. 60/459

(57) ABSTRACT

The invention relates to a hydrostatic drive system having a pump (1) and at least one consumer (6) that can be connected alternately to the pump (1) and to a tank (3) by means of a directional control valve (4) that can be actuated by control signals (15, 16), in order to control the motion of a positive or a negative load (9) at the consumer.

Provision is made to this effect that there is disposed in the line (13) of the negative connection of the consumer that leads via the directional control valve (4) to the tank (3) a pre-charge valve (5, 51, 60) that can be placed under a pressure that can be controlled via a programmable logic unit (31) when controlling a positive load.

The invention relates to a hydrostatic drive system having a pump and at least one consumer that can be connected alternately to the pump and to a tank by means of a directional control valve that can be actuated by control signals, in order to control the motion of a positive or a negative load at the consumer.

Drive systems of this type are used in work machines, for example in truck-mounted cranes. The directional control valves control the motion of a positive or a negative load at the particular consumer according to a control signal. A positive load in this context shall be understood to mean a load that counteracts the motion that is set at the consumer by means of the directional control valve. A negative load, accordingly, is a load that supports the motion that is set at the consumer by means of the directional control valve. A cable winch that, for example, moves a load in vertical direction, when lifting that load therefore is subjected to a positive load. A positive consumer connection accordingly should be understood to mean the line connection of the consumer that is connected via the directional control valve to the pump when controlling a positive load. A negative consumer connection accordingly should be understood to mean the line connection of the consumer that is connected via the directional control valve to the pump when controlling a negative load. Correspondingly, when a negative load is controlled, the positive line connection is connected via the directional control valve to the tank.

When setting into motion a positive load, operating states can arise in which only a low pressure is built up on the outlet side of the consumer against the line resistances and the resistances of the directional control valve. This is the case in particular at low consumer speeds with associated low quantities of oil supplied via the directional control valve. In order to be able to achieve a precise control behavior of the motion of the load, it is known to pre-charge the outlet line toward the tank by means of a pre-charge valve. A customary embodiment are spring-biased pre-charge valves that normally build up the pressure to between 3 and 5 bar.

This embodiment of the pre-charge involves the shortcoming that the pre-charge cannot be adjusted during operation of the system to the conditions prevailing at the particular moment. A pre-charge that is too low can manifest itself in a deteriorated control behavior, a pre-charge that is too high can manifest itself in increased energy consumption and increased heat input. Moreover, the selected pre-charge may be viscosity-dependent and therefore temperature-dependent.

The aim of the present invention is to provide a drive system in which the pre-charge at the negative consumer connection can be freely controlled or regulated when controlling positive loads.

This aim is achieved according to the invention in such a way that there is disposed in the line of the negative connection of the consumer that leads via the directional control valve to the tank a pre-charge valve that can be placed under a pressure that can be controlled by a programmable logic unit when controlling a positive load.

When a negative load is controlled, the pre-charge valve is not activated, no pre-charge pressure is generated. Therefore, no influence is exerted when controlling negative loads.

In a preferred embodiment of the invention, the pre-charge valve is a directly or indirectly controlled pressure-limiting valve that opens toward the tank against a spring force. It is particularly advantageous in this context when the effective surface of the pressure-limiting valve that acts in the closing direction is acted upon by the pilot pressure applied by a pilot valve that is electro-proportionally activated by a logic unit. In order to control a negative load, a check valve then needs to be provided in a known manner as a bypass of the pressure-limiting valve.

A further embodiment of the present invention provides that the pre-charge valve is a directly or indirectly activated directional control valve.

A further embodiment of the present invention provides that the pre-charge valve is a directly or indirectly activated logic valve.

A further embodiment of the invention provides that the pre-charge valve is a directly or indirectly activated flow control valve.

In a further embodiment of the invention provision is made to actively feed oil into the space between the negative line connection and the pre-charge valve via an additional pressure source, in order to maintain a pre-charge even when the consumer is not activated. This achieves that the pre-charge is applied already at the beginning of the motion of the consumer and is not built-up only by the oil flowing out at the negative line connection.

It is of added advantage to integrate the pre-charge valve into a counter balance valve or load holding valve that is required to control negative loads.

The invention and additional details of the invention will be explained in more detail below in conjunction with illustrative embodiments depicted in the schematic figures, in which:

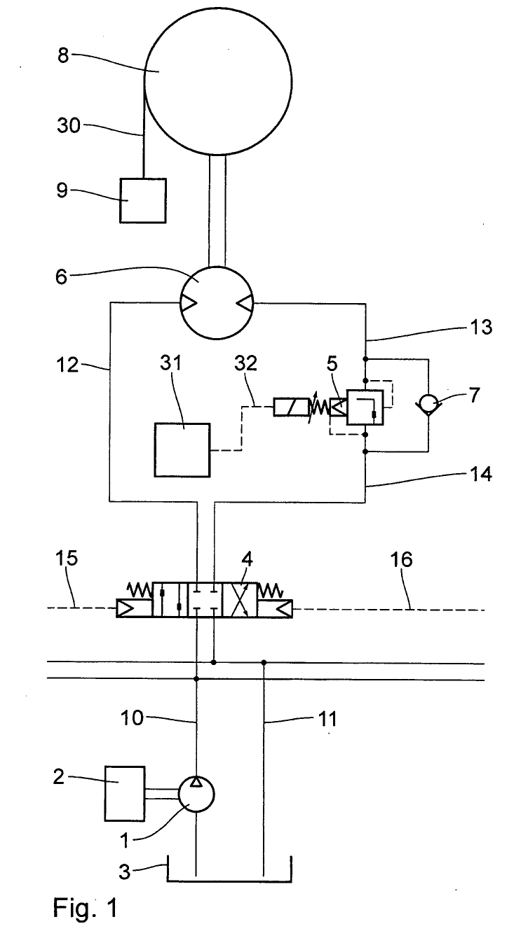

FIG. 1 shows a circuit diagram for a drive system according to the invention having a pre-charge valve designed in the form of an electro-proportional pressure-limiting valve

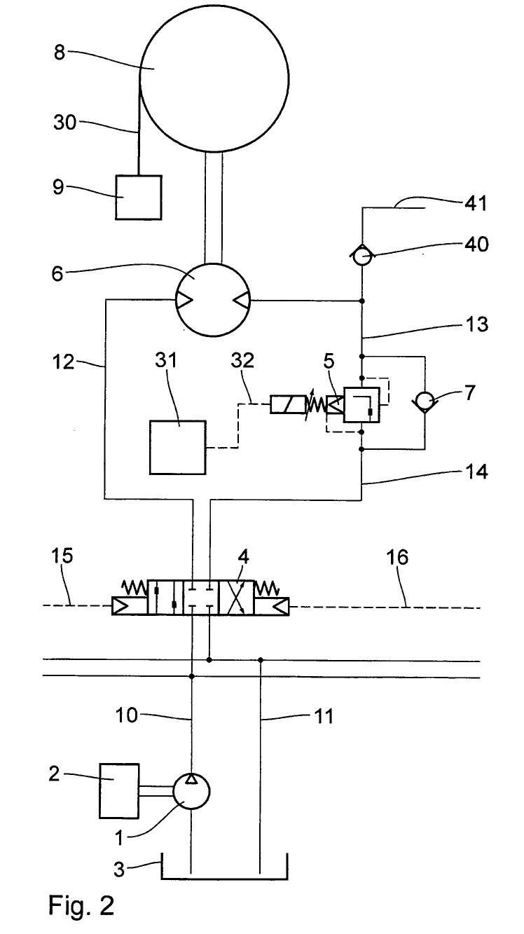

FIG. 2 shows a circuit diagram for a drive system according to the invention having a pre-charge valve designed in the form of an electro-proportional pressure-limiting valve, with additional feeding-in of a pre-charge pressure

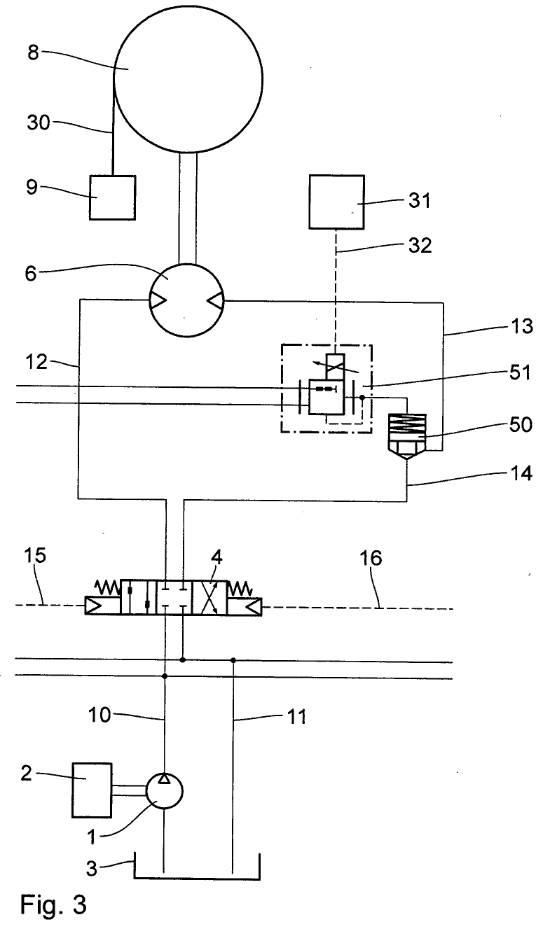

FIG. 3 shows an additional embodiment according to FIG. 1 having a directly or indirectly controlled logic valve

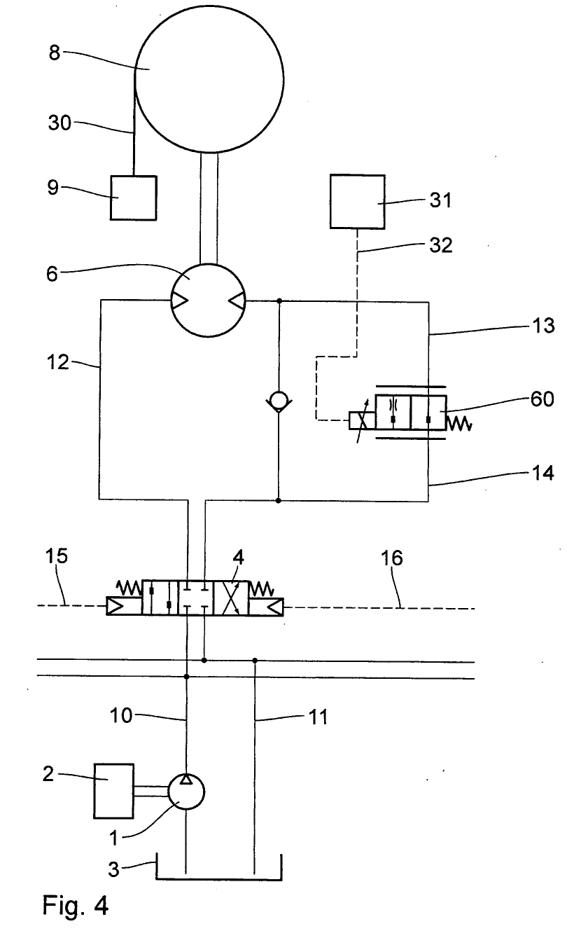

FIG. 4 shows an additional embodiment according to FIG. 1 having a directly or indirectly controlled directional control valve

FIG. 1 shows the circuit diagram for a hydrostatic drive system according to the invention having a pump 1 of constant or adjustable flow volume, driven by a drive motor 2. The pump 1 draws in pressure media from a tank 3 and pumps into a flow line 10 to the directional control valve 4. The directional control valve 4 is connected by means of the line 12 to a consumer 6 depicted in this illustrative example as a hydraulic motor having a winch 8 driven by same and a load 9 attached via a cable 30. However, the invention also has application for linear drives. A line 13 leads from the consumer 6 to the pre-charge valve 5 that is designed in the form of an electro-proportional pressure-limiting valve and to a check valve 7 that is arranged parallel thereto. The pre-charge valve 5 and the check valve 7 that is arranged parallel thereto may be physically combined in one valve. A line 14 leads from the pre-charge valve 5 and from the check valve 7 that is arranged parallel thereto to the directional control valve 4. A line 11 leads from the directional control valve 4 to the tank 3.

The directional control valve 4 is activated in this illustrative embodiment by opposing pilot pressures 15, 16. The invention also has application, however, for electrically, mechanically or pneumatically activated directional control valves. When a pilot pressure is present in the line 15, the directional control valve 4 can be actuated into the corresponding switching position and connects the flow line 10 to the line 12, and the line 14 to the outlet line 11, which, in the depicted illustrative embodiment, leads to the lifting of a positive load 9 via the winch 8 that is driven by the hydraulic motor 6. The pressure medium that is conducted away in the process from the consumer 6 into the line 13 is pre-charged by the pre-charge valve 5 to a pressure that is provided by the logic unit 31 and is communicated via lines 32 to the pre-charge valve 5. The check valve 7 prevents that the pre-charge valve 5 is bypassed by the pressure medium. When a pilot pressure is present in the line 16, the directional control valve 4 can be actuated into the corresponding switching position and connects the flow line 10 to the line 14, and the line 12 to the outlet line 11, which, in the depicted illustrative embodiment, leads to a lowering of the positive load 9 via the winch 8 that is driven by the hydraulic motor 6. The pressure medium flows from line 14 via the check valve 7 into the line 13 to the consumer 6.

In FIG. 2, pressure medium is fed into the line 13 via a line 41 and via a check valve 40 that opens into this direction of flow. This pressure medium is pre-charged via the pre-charge valve 5 to the pressure that is provided by the logic unit 31. Because of this pre-charge, the consumer 6 is pre-charged even when it is not activated.

FIG. 3 shows an embodiment according to the invention in which the pre-charge valve is a logic valve 50. The pre-charge is created by the action upon an effective surface of the logic valve by a pilot pressure that is applied by a pilot valve 51. The pilot valve 51 is actuated in a known manner by the logic unit 31 via the line 32.

FIG. 4 shows an embodiment according to the invention, in which the pre-charge valve is a directional control valve 60 that can be activated by the logic unit 31.

1. A hydrostatic drive system having a pump (1) and at least one consumer (6) that can be connected alternately to the pump (1) and to a tank (3) by means of a directional control valve (4) that can be actuated by control signals (15, 16), in order to control the motion of a positive or a negative load (9) at the consumer (6), characterized in that there is disposed in the line (13) of the negative connection of the consumer that leads via the directional control valve (4) to the tank (3) a pre-charge valve (5, 51, 60) that can be placed under a pressure that can be controlled via a programmable logic unit (31) when controlling a positive load.

2. A hydrostatic drive system as claimed in claim 1, wherein when a control signal (15) for controlling the motion of a positive load is present, an effective surface acting in the closing direction of the pre-charge valve (5) can additionally be acted upon by a pressure.

3. A hydrostatic drive system as claimed in claim 1, wherein a throttle that can be varied in the cross section thereof is provided as the pre-charge valve.

4. A hydrostatic drive system as claimed in claim 3, wherein the throttle that can be varied in the cross section thereof is designed as a directional control valve (60) throttling in intermediate positions.

5. A hydrostatic drive system as claimed in claim 3, wherein the throttle that can be varied in the cross section thereof is a logic valve (50).

6. A hydrostatic drive system as claimed in claim 1, wherein the line (13) between the negative connection of the consumer (6) and the pre-charge valve (5) can be pre-charged by an oil flow entering from an additional line (41).
